(19) United States
(12) Patent Application Publication
(10) Pub. No.: US 2025/0269367 A1
(43) Pub. Date: Aug. 28, 2025

(54) DEVICE FOR ANALYZING AN AQUATIC POLLUTANT AND/OR A LIVING ORGANISM AND USES THEREFOR

(71) Applicant: SAS PLASTIC@SEA, Saint-Andre (FR)

(72) Inventor: Anne-Leila MEISTERTZHEIM, Saint-Andre (FR)

(21) Appl. No.: 18/855,235

(22) PCT Filed: Apr. 6, 2023
(86) PCT No.: PCT/EP23/59104

§ 371 Date: Nov. 8, 2024

(30) Foreign Application Priority Data
Apr. 8, 2022 (FR) FR2203230

(51) Int. Cl. B01L 3/00; C12Q 1/02; G01N 33/18

(52) U.S. Cl. CPC B01L 3/502; C12Q 1/02; G01N 33/1893; B01L 2200/025; B01L 2200/026; B01L 2200/028; B01L 2200/0689; B01L 2300/042; B01L 2300/0609; B01L 2300/0681; B01L 2300/0832; B01L 2300/12; G01N 33/1866

(57) ABSTRACT

The device for analyzing an aquatic pollutant and/or a living organism in an aquatic environment. The analysis device includes at least one module and at least two closing end pieces. The module includes a central body defining an analysis chamber and configured to contain an aquatic organism of a given size and/or an aquatic pollutant. The central body is hollow and delimited by at least one peripheral wall, a first end and a second end. At least one closing end piece is open and includes an opening or is closed and forms a cap. The analysis device includes a connector and a mechanism for accommodating a screen. The invention also relates to the use of the analysis device, in particular in a closed environment or in an open environment with a view to reproducing a natural aquatic environment.

### CROSS-REFERENCE TO RELATED APPLICATIONS

See Application Data Sheet.

### STATEMENT REGARDING FEDERALLY SPONSORED RESEARCH OR DEVELOPMENT

Not applicable.

### THE NAMES OF PARTIES TO A JOINT RESEARCH AGREEMENT

Not applicable.

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Not applicable.

### STATEMENT REGARDING PRIOR DISCLOSURES BY THE INVENTOR OR A JOINT INVENTOR

Not applicable.

### BACKGROUND OF THE INVENTION

### 1. Field of the Invention

The present invention falls within the field of aquatic pollution impact studies. In this context, the invention relates more precisely to a device for analyzing the behavior of aquatic pollutants and/or a living organism in an open or closed aquatic environment.

### 2. Description of Related Art Including Information Disclosed Under 37 CFR 1.97 and 37 CFR 1.98

Studying the behavior of aquatic pollutants and their interaction with living aquatic organisms is an extremely complex task. Studies in the natural environment pose problems for monitoring the behavior of both living organisms and the aquatic pollutants they come into contact with. In fact, it is difficult to isolate an event that leads to the development of a pollutant, such as the biodegradation of plastic in an aquatic environment. Likewise, it is equally difficult to assess the capacity of a living organism to bio-assimilate a pollutant, as well as its capacity to eliminate it.

At the same time, it is equally complex to reproduce an aquatic environment, whether marine, freshwater or brackish water, in order to study the behavior of pollutants and/or living organisms interacting with these pollutants.

It should be noted that WO 2004/081530 describes a method for the environmental monitoring and bioprospecting of microorganisms in situ, that is, in a natural aquatic environment. The method uses an analysis device that is immersed in situ. This analysis device comprises a central body containing a fluid inlet and outlet. The central body is equipped with a plurality of capillaries, each capillary forming a microsystem. The capillaries comprise a filter that acts as a support for the development of microorganism colonies. Nevertheless, this filter is porous enough to allow water from the aquatic environment to circulate through a capillary. It is then possible to study the evolution of colonies of microorganisms produced in capillary micro-ecosystems. However, this type of system does have its limitations and drawbacks. The device described in WO 2004/081530 is designed specifically to study micro-ecosystems in capillaries and is not transposable to the study of various aquatic pollutants or macroscopic organisms. Furthermore, the in-situ nature of the analysis device makes regular analysis of the evolution of a capillary microsystem a constraint. This is because the researcher has to take the device out of the water to take samples. Each removal can influence the evolution of a micro-ecosystem through, for example, a supply of oxygen.

There are also methods for studying the biodegradation and/or bioaccumulation of pollutants in aquariums. For example, the biodegradability of plastic pollutants in the marine environment is studied in two stages. It includes an initial polymer incubation stage in the natural marine environment, followed by a second stage in which the plastic material and its biofilm are transferred to an aquarium without any other carbon source. However, reproducing a natural aquatic environment, whether marine or freshwater, is a highly complex task. This is because reproducing an artificial aquatic environment such as an aquarium necessarily involves unintended interactions between experimental elements and the materials or chemicals used to reproduce the natural aquatic environment. They contain plastics, metals and stabilizers of physical/chemical conditions such as chlorine, which can influence results.

Document ES 2 435 794 proposes an alternative to study in an aquarium. This document proposes the use of a reactor consisting of an Erlenmeyer flask containing a sample of an organic polymer immersed in water. The reactor of such devices is sealed by a cap with an air inlet and an air outlet. These airways are connected to probes measuring the release of carbon dioxide and oxygen. However, this document does not reproduce a natural aquatic environment in such a way as to mimic the behavior of an aquatic pollutant and/or an organism living in a natural environment. These devices and methods are also unsuitable for studying the bio-assimilation and elimination of pollutants by living organisms.

Also known from WO 2019/145512 is a module for trapping chemical compounds from an aquatic environment, comprising a central cylindrical tube with openings arranged around its periphery, a hollow porous reservoir which is inserted around the cylindrical tube, the reservoir being designed to contain a trapping material. Multiple identical modules can be assembled in series or in parallel to be supplied via a pump with fluid from an aquatic environment to capture organic molecules and other chemical compounds. These modules and this device are therefore in no way suitable for analyzing the behavior of aquatic pollutants and/or of an organism living in an open or closed aquatic environment.

Having studied the prior art, it appears that there is no analysis device that allows an aquatic pollutant and/or living organism to be placed in an aquatic environment benefiting from natural physical, chemical, and microbiological conditions (free circulation of microorganism strains) while being isolated from disruptive elements such as other pollutants and/or predatory living organisms.

In this context, the applicant has developed a technical solution providing a chamber for analyzing the behavior of an aquatic pollutant and/or a living organism capable of reproducing a natural aquatic environment ex situ, that is, reproducing an aquatic environment in a laboratory environment.

### BRIEF SUMMARY OF THE INVENTION

To this end, the invention relates to a device for analyzing an aquatic pollutant and/or an organism living in an aquatic environment, comprising at least one module comprising a hollow central body and at least two closing end pieces, the central body defining an analysis chamber and being configured to contain a living organism of a given size and/or an aquatic pollutant:
the central body is delimited by at least one peripheral wall, a first and a second end and comprises at each of its ends a female or male interlocking portion configured to cooperate with a male or female interlocking section, respectively, of a closing end piece and/or a male or female interlocking portion of the central body of an adjacent module, the central body of one module being removably connected to the central body of an adjacent module and/or to a closing end piece;
at least one closing end piece is open and has an opening, or is closed and forms a cap;
the analysis device comprises connection means arranged at a junction between one end of the central body of a module and a end piece and/or between a first end of the central body of a module and a second end of the central body of an adjacent module;
the analysis device further comprises an accommodation means designed to ensure the immobilization of a screen having openings whose cross-section is smaller than the dimensions of the living organism and/or of a pollutant intended to be contained in the analysis chamber of the central body of a module, the accommodation means being arranged at one end of the central body of and/or at the end piece;
the central body of a module and the end pieces are made of inert material;
the central body of a module comprises at least one auxiliary channel extending from the peripheral wall of the central body to the outside of the analysis device, the auxiliary channel being adapted to be connected to an auxiliary element selected from the following list: a nutrient supply source, a pollutant supply source, an air supply source, an oxygen supply source, a measuring instrument, or a combination of these elements.

Advantageously, the central body comprises a fixed or removable support configured to support a pollutant in a cohesive state and/or a living organism.

According to the invention, the connection means are of the screw-nut type.

According to another feature of the invention, the analysis device comprises at least one screen arranged at the accommodation means.

According to yet another feature of the invention, the analysis device can have one closed end and one open end or two open ends or two closed ends.

According to another feature of the invention, an end piece comprises a second, reclosable auxiliary opening.

According to the invention, the analysis device comprises at least two modules mounted in series and abutting through one of the ends of each of the central bodies of these modules, the central body of one module having one end abutting one end of the central body of a following module, the central body of the first module cooperating through one end with a first end piece, one end of the central body of the last module receiving a second end piece.

The invention also relates to the use of the analysis device for behavioral studies in an open aquatic environment of at least one aquatic pollutant, the end pieces each comprising at least one opening, defining an analysis device mounted in an open circuit.

The invention also relates to the use of the analysis device for studying the behavior in a closed aquatic environment of at least one aquatic pollutant and/or at least one bacterial colony pre-seeded within a bacterial biofilm on a substrate such as a plastic material, the analysis device comprising two closed end pieces, so as to generate a closed aquatic environment within the analysis device.

The analysis device can be used in either a horizontal or vertical position.

### BRIEF DESCRIPTION OF THE SEVERAL VIEWS OF THE DRAWINGS

Other features and advantages will appear in the following detailed description of a non-limiting embodiment of the invention, which is shown by the enclosed FIGS. 1 to 9.

FIG. 1 shows an exploded perspective view of an analysis device according to the invention.

FIG. 2 shows a perspective view of an analysis device with two modules connected in series for open-circuit operation.

FIG. 3 shows a perspective view of the central body of a module of the analysis device shown in FIG. 1.

FIG. 4 shows a perspective view of an analysis device with two modules connected in series for closed-or semi-closed-circuit operation.

FIG. 5 shows a perspective view of a thread at one end of a central body of a module of the analysis device shown in FIG. 1, which thread cooperates with a nut comprising an end piece, the thread and nut forming connection means.

FIG. 6 shows a perspective view of a nut mounted on an end piece of the analysis device shown in FIG. 1, with the nut in the unscrewed position.

FIG. 7 shows a perspective view of an end piece with a second, auxiliary opening.

FIG. 8 also shows a perspective view of an end piece with a second, auxiliary opening.

FIG. 9 shows a perspective view of multiple analysis devices.

### DETAILED DESCRIPTION OF THE INVENTION

The present invention relates to an analysis device 1 for studying the behavior of aquatic pollutants and/or an organism living in an aquatic environment ex situ. The analysis device according to the invention contributes to the reproduction of a natural aquatic environment in a laboratory environment.

To this end, the analysis device comprises at least one module 2 comprising a central body 2a. It is hollow and configured to contain an aquatic pollutant and/or a living organism of a given size. In fact, the central body 2a defines a chamber for analyzing an aquatic pollutant and/or a living organism. Naturally, the dimensions of the central body 2a are determined according to the aquatic pollutant and/or living organism to be studied.

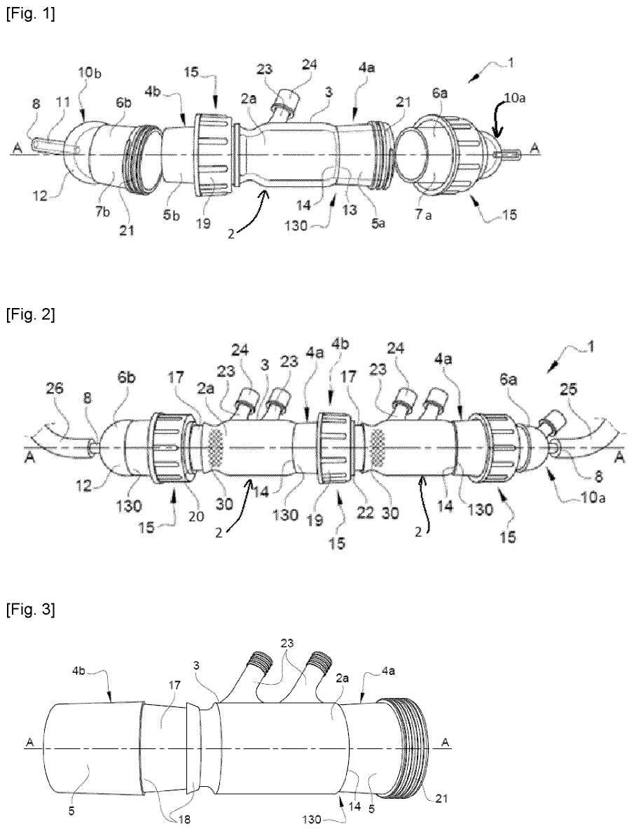

As shown in FIGS. 1 to 4, the central body 2a is bounded by at least one peripheral wall 3. In this example, the central body 2a is advantageously generally tubular in shape and extends longitudinally along a longitudinal axis A-A. It has a first end 4a and a second end 4b. The two ends 4a, 4b are opposite each other. Here, the two ends 4a, 4b longitudinally delimit the tubular central body 2a along the longitudinal axis A-A. As an example, the tubular central body 2a can extend longitudinally along an axis parallel to axis A-A over a longitudinal distance of between 5 cm and 50 cm, preferably this longitudinal distance is between 8 cm and 25 cm. Note that the longitudinal distance defines the length of the module 2. Similarly, the tubular central body 2a can have a cross-sectional area at the longitudinal axis A-A of between 1 cm and 10 cm, preferably between 3 cm and 7 cm. When the tubular central body 2a is a cylinder, its diameter corresponds to the cross-section.

Here, the central tubular body 2a is a cylinder. Nevertheless, according to the invention, it can take any other three-dimensional form able to contain a pollutant and/or a living organism. By way of illustration, the tubular central body 2a could be spherical, pyramidal, cubic, conical or other shapes.

As shown in FIG. 1, this tubular central body 2a comprises a female 5a and male 5b interlocking portion at both ends 4a, 4b respectively.

The analysis device 1, as shown in FIGS. 1 to 4, also comprises at least two closing end pieces 6a, 6b. The first end piece 6a is configured to cooperate with at least the first end 4a of the central body 2a, which is equipped with a female interlocking portion 5a. To this end, the first end piece 6a comprises a male interlocking section 7a.

This first end piece 6a may comprise an opening 8 or it may be closed to form a cap 9. Both the opening 8 and the cap 9 are arranged opposite the male interlocking section 7a. The opening 8 or the cap 9 respectively define one end 10a of the analysis device 1.

Advantageously, the first end piece 6a is removably mounted on the first end 4a of the central body 2a. This removability contributes to the insertion and removal of a pollutant and/or living organism within the analysis chamber defined by the central body 2a.

By way of illustration, the end piece 6a, 6b may extend longitudinally along an axis parallel to axis A-A over a distance of between 2 cm and 25 cm, defining the length of the end piece 6a, 6b. Preferably, the length of the end piece 6a, 6b is between 4 cm and 15 cm. Similarly, the cross-section of the end piece 6a, 6b is matched to the cross-section of the central body 2a, at its ends 4a, 4b. Thus, it is preferentially between 1 cm and 10 cm. Preferably, the diameter of the end piece 6a, 6b is between 3 cm and 7 cm. In addition, the width of the opening 8 of the end piece 6a, 6b is between 0.1 cm and 3 cm, preferably between 0.3 cm and 1.5 cm.

In addition, as shown in FIGS. 1 to 4, the analysis device 1 includes a second end piece 6b. The second end piece 6b is positioned removably at the second end 4b of the central body 2a. The second end piece 6b is configured in the same way as the first end piece 6a. On the one hand, the second end piece 6b comprises a female interlocking section 7b complementary to the male interlocking portion 5b of the second end piece 4b of the central body 2a. On the other hand, the second end piece 6b is open and has an opening 8, or the second end piece 6b is closed and forms a cap 9. The opening 8 or cap 9 of the second end piece 6b forms one end 10b of the analysis device 1.

In the example shown in FIGS. 1 and 2, the analysis device 1 is equipped with two end pieces 6a, 6b, each comprising an opening 8. This opening 8 is formed at the end of a hollow needle 11. This hollow needle 11 is arranged in the extension of a curved wall 12 of the end piece 6a, 6b which defines one end 10a, 10b of the analysis device 1. According to this configuration, the analysis device 1 comprises two open ends 10a, 10b defined by two removable end pieces 6a, 6b equipped with an opening 8. When the two end pieces 6a, 6b respectively comprise an opening 8, the analysis device 1 can be placed in an open circuit. One end 10a of the analysis device 1 is a liquid flow inlet, while the other end 10b is a fluid flow outlet. The fluid flow then circulates continuously through the analysis device 1.

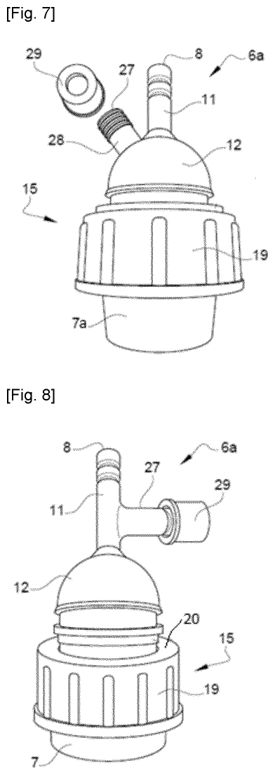

In an embodiment shown in FIG. 7, at least one end piece 6a, 6b of the analysis device 1 is equipped with a second, auxiliary opening 27. This second auxiliary opening 27 is located at the end of a hollow needle 28 on the curved wall 12. The second auxiliary opening 27 is shown here as reclosable by a screw cap fitted with a septum 29. This auxiliary opening 27 can be used as a bleed screw during the water volume adjustment stages, particularly when the analysis device 1 is in a vertical position. In fact, by opening the cap 29 of the auxiliary opening 27, the air contained in a module of the analysis device 1 can be evacuated, thus keeping it completely filled with water.

In another embodiment shown in FIG. 8, the second auxiliary opening 27 is arranged on the hollow needle 11 in an axis substantially perpendicular to the longitudinal axis of the hollow needle 11. A fitting, such as a tubular borosilicate glass fitting, can be placed at the outlet of the second opening 27, to prevent the accumulation of solid particles, for example when the pollutant is in the form of floating particles.

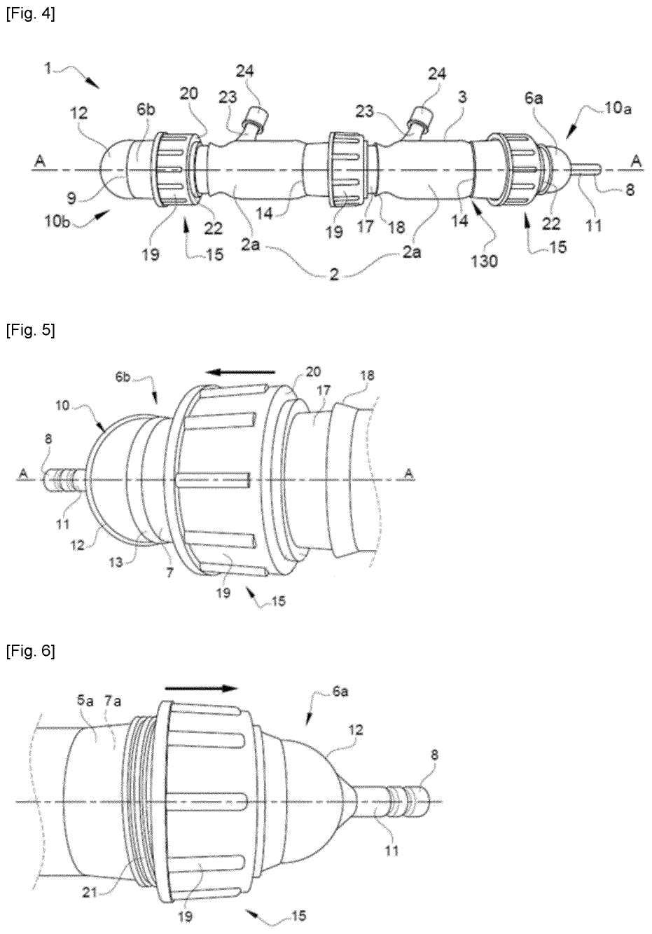

Note that in the example shown in FIG. 4, the first end piece 6a has an opening 8, while the second end piece 6b forms a cap 9. Here, the cap 9 corresponds to the curved wall 12 of the second end piece 6b at the end 10b of the device 1. In this case, the curved wall 12 is closed. The cap 9 can also have a flat shape. When the analysis device 1 comprises a cap 9 at a end piece 6a, 6b. This device is then configured as a closed environment, the fluid flow being stagnant or renewed through the end piece 6a comprising the opening 8. In this configuration, the analysis device 1 comprises a closed end 10b, an open end 10a and at least one removable end piece 6a, 6b. This configuration provides an analysis chamber reproducing a closed aquatic environment.

Generally speaking, the male interlocking section 7a of the first end piece 6a is complementary to the female interlocking portion 5a of the first end 4a of the central body 2a. In particular, the male interlocking section 7a cooperates with the female interlocking portion 5a by interlocking. These features are reversed in the cooperation between the second closing end piece 6b and the second end 4b of the central body 2a.

As shown in FIGS. 1 to 4, preferably the first end 4a of the central body 2a is equipped with a female member, while the other end 4b of the central body 2a is equipped with a male member. This inverted configuration of ends 4a, 4b enables two modules 2 to be connected directly in series by interlocking the complementary ends 4a, 4b of their central body 2a. As shown in FIG. 2, the analysis device 1 may comprise a plurality of modules 2 connected in series. This makes it possible to check the reproducibility of the analyses or to carry out a study on multiple different living organisms or of the same type, or on multiple different aquatic pollutants or of the same type.

In this example, the male and female members are frustoconical in shape. The male member has slightly smaller dimensions than the female member for interlocking purposes. The frustoconical shape ensures perfect, rapid centering of the male member in relation to the female member. This configuration also improves leak-tightness.

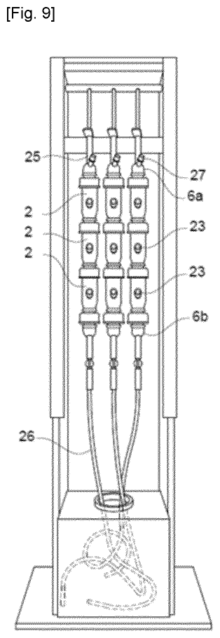

The analysis device 1 can be used in either a horizontal or vertical position. In a non-limiting example of use, as shown in FIG. 9, multiple modules 2 are mounted in series and in a vertical position, forming an analysis system. Multiple analysis systems can be suspended from support means, such as an arm. In this case, the described system comprises hooking means, as well as means for supplying fluid, for example water, with one or more distributors. These supply means correspond to the water recirculation means, more precisely the inlet ducts 25. Preferentially, the water inlet ducts 25 are chosen from inert materials.

As shown in FIGS. 1 to 4, the analysis device 1 further comprises an accommodation means 130 which is designed to immobilize a screen 13 arranged transversely to the central axis 2a. According to a first embodiment, the accommodation means 130 is arranged at one end 4a, 4b of the central body 2a. According to a second embodiment, this accommodation means 130 can also be arranged on an end piece 6a, 6b.

As shown in FIGS. 1 to 3, the accommodation means 130 comprises at least one internal shoulder 14 arranged substantially between the male or female interlocking portion 5a, 5b of one end 4a, 4b of the central body 2a. Here, the first end 4a of the central body 2a carries the internal shoulder 14.

Alternatively, the analysis device 1 may comprise at least one internal shoulder 14 arranged at a end piece 6a, 6b. In particular in this configuration, the internal shoulder 14 is arranged between the male or female interlocking section 7a, 7b and the end 10a, 10b of the end piece 6a, 6b. The internal shoulder 14 supports the screen 13.

The function of the screen 13 is to allow a fluid flow, preferably laminar, through the analysis device 1, while preventing the pollutant or organism from escaping from the central body 2a of a module 2. To this end, the screen 13 has openings whose cross-section is adapted to the dimensions of the living organism and/or to the dimensions of a pollutant intended to be contained in the central body 2a. This screen 13 is removable from a module 2 of the analysis device 1. The removability of the screen 13 provides easy access to the analysis chamber of the central body 2a, for example, to introduce and/or extract the pollutant and/or living organism of interest.

More precisely, the screen 13 is arranged at a junction between one end 4a, 4b of the central body 2a and the end piece 6a, 6b with which said end 4a, 4b cooperates.

To ensure that the screen 13 is held in position, it is preferable to use the end 4a, 4b of the central body 2a carrying the internal shoulder 14 as a fluid flow inlet. In parallel, in an open circuit, the end piece 6a, 6b forming the fluid flow outlet also carries an internal shoulder 14 supporting a screen 13. More generally, for the internal shoulder 14 to provide support for a removable screen 13, it must necessarily exert a reaction opposite to the direction of the fluid flow. As shown in FIG. 1, a second screen 13 can also be positioned at the junction between the second end 4b of the central body 2a and the second removable end piece 6b.

As shown in FIGS. 1, 2 and 4, the analysis device 1 also comprises connection means 15. These connection means 15 are arranged at a junction between one end 4a, 4b of the central body 2a and an end piece 6a, 6b cooperating with said end 4a, 4b. The connection means 15 enable the analysis device 1 to be hermetically sealed at the junction between one end 4a, 4b of the central body 2a and an end piece 6a, 6b. Advantageously, these connection means 15 are of the screw-nut type.

In this way, the female interlocking section 7b of the end piece 6b has a thread 21 on its periphery suitable for cooperating with a nut 19 mounted, preferentially but not necessarily, for free rotation on the end 4b, provided with the male interlocking portion 5b, of the central body 2a, while the female interlocking portion 5a at the end 4a of this central body 2a comprises a thread 21 able to cooperate with a nut 19 mounted, preferentially but not necessarily, to freely rotate, on the end piece 6a equipped with the male interlocking portion 7a.

The nuts 19 can be freely rotatably mounted through a peripheral groove 17 formed, in one case, at the end 4b of the central body 2a and, in the other case, on the closing end piece 6a, advantageously between the male interlocking section 7a and the end 10a of the device 1 defined by this closing end piece 6a. In both cases, the peripheral groove 17 is formed by two external shoulders 18 spaced apart by a given distance. The two external shoulders 18 are formed on an outer wall of the central body 2a or alternatively on an outer wall of an end piece 6a. It should be noted that the peripheral groove 17 can be defined as frustoconical between the two external shoulders 18.

The nut 19 advantageously comprises an annular flange 20 extending into the peripheral groove 17, allowing rotational displacement of the nut 19 and, if necessary, axial displacement along a path determined by the distance separating the two external shoulders 18.

According to an advantageous embodiment, this stroke is determined to enable nut 19 to move from a screwed-in position, visible in FIGS. 2, 4 and 5, to an unscrewed position, as shown in FIGS. 1 and 6, wherein an interlocking section, as the case may be male 7a or female 7b, can be freely engaged in an interlocking portion, respectively female 5a or male 5b.

The connection means 15 thus enable the central body 2a to be detachably connected to the end pieces 6a, 6b, ensuring that the analysis device 1 is watertight.

As shown in FIG. 4, the connection means 15 also enable the central body 2a of a first module 2 to be connected to the central body 2a of a second module 2 through the ends 4a, 4b of each central body 2a, while ensuring the sealing of the analysis device 1. In this case, the female interlocking portion 5a at the end 4a of the central body 2a of a first module 2 is engaged by the male interlocking portion 5b at the end 4b of the central body 2a of a second module 2, and the nut 19 at this end 4b of the central body 2a corresponding to this second module 2 is screwed onto the thread 21 on the female interlocking portion 5a at the end 4a of the central body 2a corresponding to the first module 2.

As shown in FIGS. 1 to 4, the analysis device 1 comprises at least one auxiliary channel 23. The auxiliary channel 23 extends from the peripheral wall 3 of the central body 2a of a module 2 towards a free end. In FIG. 2, the analysis device 1 has two auxiliary channels 23. Here, the two auxiliary channels 23 are parallel to each other. However, it is entirely possible for a first auxiliary channel 23 to extend on a first side of the central body 2a, while the second auxiliary channel 23 extends on a second side of this central body 2a.

According to the invention, the auxiliary channel 23 consists of a conduit communicating with the internal volume of central body 2a. In fact, the auxiliary channel 23 is adapted to be connected to an auxiliary element chosen from the following list: a nutrient supply source, a pollutant supply source, an air supply source, an oxygen supply source, a measuring instrument, or a combination of these elements. In this way, it is possible to regulate the supply of nutrients to the medium within the analysis device 1, both in terms of quantity and choice of nutrients. Similarly, the medium can be supplied with selected liquid or solid pollutants in specific quantities. It is also possible to control an air or oxygen supply using the same principle. This enables the user to control, regulate, and study the influence of various parameters on the behavior of aquatic pollutants and/or an organism living in an aquatic environment within the analysis device 1. The auxiliary channel 23 also allows a measuring instrument to be inserted into the central body 2a of a module 2. This makes it possible to measure the behavioral data of the aquatic pollutant and/or a living organism.

The analysis device 1 may also include a pump, for example of the peristaltic type. By way of example, the pump can be used to convey nutrients, air, or the like from a source to the central body 2a of a module 2 of the analysis device 1. In this sense, the pump can be interposed between the central body 2a and the source of nutrient, pollutant supply, air etc., which are introduced via the auxiliary channel(s) 23 by means of a peristaltic pump.

In addition, the auxiliary channel 23 can be used to add liquid solutions or gases to or remove them from the central body 2a of a module 2 during experiment preparation or experimentation, without any time limit.

As shown in FIGS. 1, 2 and 4, the free end of the auxiliary channel 23 can be provided with a gland device 24 to ensure a sealed connection with an auxiliary element as described above or a routing conduit.

As shown in FIG. 2, the analysis device 1 may also comprised a fixed or removable support 30 configured to support a pollutant in a cohesive state and/or a living organism. The support 30 can be fixed and formed by pins or nubs integrated into the central body 2a of a module 2. Alternatively, the support 30 can be removable, such as a strainer or basket. This support 30 can take the form of a lattice.

For example, the aquatic pollutant placed in the analysis chamber may be a plastic material. It is then possible to study the biodegradability of this pollutant by aquatic microorganisms.

In order to avoid any disruption of the study to be carried out in the analysis device 1, it is preferable that the material used to form the central body 2a of a module 2, the end pieces 6a, 6b, the auxiliary channel 23 and the support 30 be biologically and chemically inert. To this end, the central body 2a, closing end pieces 6a, 6b, auxiliary channels 23 and support 30 as described by the invention and shown in FIGS. 1 to 4 are made of glass. The glass used is preferably borosilicate glass. The use of glass also makes it possible to resist the corrosion induced by the presence of pollutants and by the salinity of the water when using the analysis device 1 in brackish water or seawater.

The living organism that can be positioned in the central body 2 may be a higher living organism such as a mussel. Mussels are used as a bioindicator of pollutant bioaccumulation. The presence of both the bioindicator species and a selected aquatic pollutant in analysis device 1 enables analysis of the bioassimilation and elimination of the pollutant by the living organism.

The invention also relates to a use of the analysis device 1 for the behavioral study of at least one aquatic pollutant.

For this purpose, the analysis device 1 can be used in two operating modes: in an open environment or in a closed environment.

In an open environment, the end pieces 6a, 6b at the ends 10a, 10b of the analysis device 1 are open. The two open ends 10a, 10b define an open-circuit analysis device 1. In this context, a first end piece 6a and a first end 4a of the central body 2a of a module 2 constitute a water inlet, while a second end piece 6b and a second end 4b of the central body 2a, as the case may be, of the same module 2 or of another module 2 constitute an outlet for the water flowing through the central body 2. It should be noted that the water inlet to the analysis device 1 can be supplied by a pump that draws water from a specific natural environment. The analysis device 1 is then placed in a laboratory close to this natural environment. This makes it possible to reproduce, in the laboratory, the aquatic conditions of a natural environment such as the Mediterranean, an oceanic lagoon, a saltwater lagoon, a freshwater lake, or a river.

In this context, the analysis device 1 can be integrated into a system for analyzing an aquatic pollutant and/or a living organism. As shown in FIG. 2, this analysis system comprises an inlet duct 25, one free end of which is arranged within a natural environment. The free end of the inlet duct 25 can also be placed in a tank or reservoir of water reproducing the natural environment to be studied. The free end is an inlet opening for water from the natural environment. The inlet duct 25 is connected to the water inlet of the analysis device 1. The system comprises a pump which is configured to project water taken from the natural environment through the inlet duct 25 and analysis device 1. It should be noted that the inlet opening and/or inlet duct 25 may comprise grids and screens to prevent aquatic debris or living organisms from being sucked out of the natural environment. At the outlet of the analysis device 1, the analysis system comprises a discharge duct 26 for the water that has passed through the analysis device 1. The discharge duct 26 conveys the water used to generate the aquatic environment in analysis device 1 to the natural environment or a reservoir or similar.

When an analysis device 1 comprises a single module 2, a end piece 6a, 6b is mounted on each end 4a, 4b of the central body 2a of this module. In fact, each end 4a, 4b can be equipped directly or indirectly with a screen 13 as previously described. In addition, the screen 13 is chosen according to the dimensions of the aquatic pollutant and/or the dimensions of the living organism to be studied.

As shown in FIG. 2, the analysis device 1 may comprise two or more modules 2 connected in series and operating in an open environment. In this configuration, the modules 2 are butted through the ends 4a, 4b of the central body 2a of each module 2 as described above. According to this configuration, a screen 13 can be arranged at the accommodation means 130 at the inlet of each module 2, and the last module 2 in a series can also comprise a screen 13 at the accommodation means 130 at its outlet end, this outlet end corresponding to the second end piece 6b. The order of the modules 2 of each analysis device 1 is determined by the direction of water flow. In the example shown in FIG. 2, the analysis device 1 comprises two modules 2 abutted at one end 4a, 4b respectively. The first module 2 is connected to a first hose through its water inlet. The first hose is the water inlet duct 25. Conversely, the second module 2 is connected to a second hose through its water outlet. The second hose forms the water discharge duct 26.

As previously described, the analysis device(s) 1 can be used in either a horizontal or vertical position. As shown in FIG. 9, multiple analysis devices 1 can be used in a vertical position. The analysis devices 1 comprise multiple modules 2 connected in series. The analysis devices 1 are suspended from support means, such as a jib, via hooking means. The analysis devices 1 are supplied with water via their water inlets 25 and are connected via their water outlets to water discharge ducts 26. A distributor can also be arranged at the feed means.

The system pump controls the flow of water taken from the natural environment or reservoir and injected into the analysis device(s) 1. As a guide, the water flow rate is estimated at between 50 mL/hour and 900 mL/hour, preferentially between 200 mL/hour and 600 mL/hour. This water flow rate reproduces natural water flows. The analysis system is said to be open, involving water circulation within the analysis device 1 which reproduces the natural environmental conditions of the behavior of aquatic pollutants or living organisms. This open analysis system makes it possible, for example, to study the biodegradation of aquatic pollutants such as plastic film, or the way in which a living organism assimilates or accumulates an aquatic pollutant and/or the way in which this living organism degrades or evacuates an aquatic pollutant. This type of phenomenon is known as bio-assimilation or bio-accumulation, and can be measured for pollutants such as heavy metals, plastic particles, etc. It is also possible to measure the toxicity of a pollutant by means of a suitable instrument which interacts with the central body 2 via an auxiliary channel 23.

When the analysis device 1 is used in a closed environment, the analysis device 1 comprises at least one closed end. Preferably, the analysis device 1 has two closed ends. The closure of the environment contributes to the creation of a closed or semi-closed aquatic environment within the analysis device 1. This mode of use of the analysis device 1 is useful when studying nanoparticles. For example, the biodegradation of plastic by bacteria in an aqueous medium releases plastic nanoparticles. However, when the analysis device 1 is used in open mode, the nanoparticles are not retained by the screen pores, so it is not possible to study them.

In a closed environment, it is possible to reproduce a natural aquatic environment by taking a specific quantity of water from it. As in the case of the open environment, this sampling can be carried out via an inlet duct 25, the mouth of which is immersed in the natural aquatic environment. A pump and valve system can be used to control the amount of water initially introduced into the analysis device 1, as the pollutant and/or living organism of interest can be introduced before or after the water is introduced.

However, in order to reproduce natural conditions, it is necessary to oxygenate the water in the analysis device 1. In this context, an auxiliary channel 23 of the analysis device 1 can be used to oxygenate the water contained in the analysis device 1. For example, auxiliary channel 23 can be connected to an oxygenation tank, with the water being renewed via a pump. This is why it is possible to call it a semi-enclosed environment. The pump can be of the peristaltic type described above. It is also possible to use an oxygen bubbler connected directly to the auxiliary channel 23. In this case, the oxygenation tank and oxygen bubbler are a source of oxygenation.

In the example shown in FIG. 4, the analysis device 1 comprises 2 series-connected modules 2 operating in a closed environment. According to this configuration, the modules 2 are abutted through one of the ends 4a, 4b of each of the central bodies 2a as described above. In this example, the central body 2a of the first module 2 has its end 4b abutting the end 4a of the central body 2a of the second module 2. In addition, the central body 2a of the first module 2 cooperates through one of its ends 4a with a first end piece 6a comprising an opening 8. Conversely, the end 4b of the central body 2a of the second module 2 receives a second end piece 6b forming a cap 9.

In the example shown in FIG. 4, a screen 13 is arranged at the inlet to the central body 2a of each module 2 connected in series, while the second end piece 6b also features a screen 13. The order of the modules 2 of each analysis device 1 is determined by the direction of water intake into the analysis device 1. The central body 2a of at least one module 2 has at least one auxiliary channel 23, and in the example shown in FIG. 4, the central body 2a of each module 2 has one auxiliary channel 23 each.

The analysis device 1 can also be used to study the metabolic behavior of a living organism in the presence of an aquatic pollutant. Depending on the nature of the living organism or the parameters to be measured, it is possible to work with one or more analysis devices 1 in a closed or open environment. In both cases, a living aquatic organism is placed in the analysis chamber of the central body 2a of a module 2 of the analysis device 1. This comprises at least one auxiliary channel 23 and at least one auxiliary element. In this case, the auxiliary element may comprise a pollutant source such as a water reservoir in which nanoparticles of pollutants are suspended.

Using appropriate tools, it is possible to assess the bio-assimilation and/or elimination of an inert pollutant such as plastic nanoparticles. It is also possible to assess the toxicity of an aquatic pollutant such as a heavy metal.

The analysis device 1 described and shown in FIGS. 1 to 4 is also used to study the bio-assimilation and elimination of aquatic pollutants by a living organism. The living organism serves as a bioindicator. For example, a mussel can be used as a bioindicator.

The mussel is one of the shellfish that screens the largest quantity of seawater, making it a good model for studying the bio-assimilation and elimination of inert aquatic pollutants such as plastic. Here, a mussel is inserted into the analysis device 1 and immersed in the central body 2a of a module 2. It can be used in open or closed environments. The intake likewise comes via the auxiliary channel(s) 23. The use of the analysis device 1 thus makes it possible to analyze not only the quantity of pollutant assimilated by the living organism over a given period, but also the time taken for this quantity of pollutant to be eliminated.

The analysis device 1 can also be used to study the behavior of bacteria. In this case, a bacterial colony can be pre-seeded within a bacterial biofilm on a support such as a plastic material. The use of an analysis device 1 as described by the invention makes it possible to study the evolution of the bacteria colony over time, but also the degradation of the plastic material as a function of the evolution of the bacteria colony.

Generally speaking, an auxiliary element can be chosen from the following list: a nutrient supply source, a pollutant supply source, an air supply source, an oxygen supply source, a measuring instrument, or a combination of these elements.

The oxygenation and feeding of organisms, as well as the addition of pollutants or any other solid or liquid element, can be achieved by using at least one auxiliary channel 23 in combination with at least one auxiliary element. Of course, auxiliary channels 23 can be used in both open and closed environments. The analysis system can also include a pump as described above which is connected to a supply source such as nutrients, pollutants, air or oxygen. An auxiliary channel 23 also provides easy access to the heart of the analysis chamber for inserting measuring instruments such as probes for quantifying carbon dioxide or oxygen levels, temperature probes, probes for quantifying the content of various chemical elements, these examples being non-limiting.

In addition, the use of the analysis device 1 in a closed environment enables the control and regulation of the external intake, and thus the ability to evaluate the influence of a given nutrient addition in a given quantity over time. The same applies to oxygen intake. These intake examples are not exhaustive.

[symbol]

I claim:

1. A device (1) for analyzing an aquatic pollutant and/or an organism living in an aquatic environment, comprising:
at least one module (2) being comprised of a central body (2a) and at least two closing end pieces (6a, 6b), the central body (2a) defining an analysis chamber and being configured to contain a living organism of a given size and/or an aquatic pollutant,
wherein the central body (2a) is delimited by at least one peripheral wall (3), a first end (4a) and a second end (4b) and comprises at each of its ends (4a; 4b) an interlocking portion, either female (5a) or male (5b), configured to cooperate with a male (7a) or female (7b) interlocking section, respectively, of a closing end piece (6a; 6b) and/or a male (5a) or female (5b) interlocking portion of the central body (2a) of an adjacent module (2), the central body (2a) of one module (2) being removably connected to the central body (2a) of an adjacent module (2) and/or to a closing end piece (6a, 6b),
wherein at least one closing end piece (6a, 6b) is open and comprises an opening (8), or is closed and forms a cap (9),
wherein the analysis device (1) comprises connection means (15) arranged at a junction between the end (4a, 4b) of the central body (2a) of a module (2) and an end piece (6a, 6b) and/or between the first end (4a) of the central body (2a) of a module (2) and the second end (4b) of the central body (2a) of an adjacent module (2),
wherein the analysis device (1) further comprises an accommodation means (130) designed to ensure the immobilization of a screen (13) having openings whose cross-section is smaller than the dimensions of the living organism and/or of a pollutant intended to be contained in the analysis chamber of the central body (2a) of a module (2), the accommodation means (130) being arranged at one end (4a, 4b) of the central body (2) of and/or at the end piece (6a, 6b),
wherein the central body (2a) of a module (2) and the end pieces (6a, 6b) are made of inert material, and
wherein central body (2a) of a module (2) comprises at least one auxiliary channel (23) extending from the peripheral wall (3) of the central body (2a) to the outside of the analysis device (1), the auxiliary channel (23) being adapted to be connected to an auxiliary element selected from the following list: a nutrient supply source, a pollutant supply source, an air supply source, an oxygen supply source, a measuring instrument, or a combination of these elements.

2. The analysis device, according to claim 1, wherein the central body (2a) comprises a fixed or removable support (30) configured to support a pollutant in a cohesive state and/or a living organism.

3. The analysis device, according to claim 1, wherein the male interlocking section (7a) of a first end piece (6a) is complementary to the female interlocking portion (5a) at the first end (4a) of the central body (2a) and wherein the female interlocking section (7b) of a second end piece (6b) is complementary to the male interlocking portion (5b) at the second end (4b) of said central body (2a).

4. The analysis device, according to claim 1, wherein the connection means (15) are of the screw-nut type.

5. The analysis device, according to claim 1, wherein the male interlocking section (7b) of the end piece (6b) has on its periphery a thread (21) able to cooperate with a nut (19), mounted on the second end (4b), provided with the female interlocking portion (5b), of the central body (2a) of a module (2), the female interlocking portion (5a) at the first end (4a) of the central body (2a) of this module (2) comprising a thread (21) able to cooperate with a nut (19), either one that is mounted on the end piece (6a) equipped with the male interlocking section (7a) or one that is mounted on the second end (4b), provided with the female interlocking portion (5b), of the central body (2a) of an adjacent module (2).

6. The analysis device, according to claim 5, wherein a nut (19) is mounted freely rotatably, as the case may be, on the second end (4b), provided with the male interlocking portion (5b), of the central body (2a) and/or on the end piece (6a) equipped with the male interlocking section (7a).

7. The analysis device, according to claim 6, wherein the second end (4b) of the central body (2a) and/or the end piece (6a) comprises a peripheral groove (17) formed by two external shoulders (18) arranged at a given distance from one another, a nut (19) comprising an annular flange (20) extending freely rotatable in said peripheral groove (17).

8. The analysis device, according to claim 7, wherein the distance separating the two external shoulders (18) of the peripheral groove (17) allows axial displacement of the nut (19) by a given distance to enable the nut (19) to move from a screwed-on position to an unscrewed position.

9. The analysis device, according to claim 1, further comprising; at least one screen (13) arranged at the accommodation means (130).

10. The analysis device, according to claim 9, wherein the accommodation means (130) comprises at least one internal shoulder (14) for positioning and holding the screen (13) on at least one end (4a, 4b) of the central body (2).

11. The analysis device, according to claim 9, wherein the screen (13) has openings with a cross-section smaller than that of a living organism and/or with the dimensions of an aquatic pollutant

12. The analysis device, according to claim 1, further comprising: a closed end (10b) and an open end (10a).

13. The analysis device, according to claim 1, further comprising: two open ends (10a, 10b).

14. The analysis device, according to claim 1, wherein the inert material of the central body (2a), the end pieces (6a, 6b) and the auxiliary channels (23) is borosilicate glass.

15. The analysis device, according to claim 1, wherein the end piece (6a, 6b) comprises a second, auxiliary, reclosable opening (27).

16. The analysis device, according to claim 1, further comprising: at least two modules (2) mounted in series and abutting through one of the ends (4a, 4b) of each of the central bodies (2a) of these modules (2), the central body (2a) of one module (2) having its second end (4b) abutting the first end (4a) of the central body (2a) of a following module (2), the central body (2a) of the first module (2) cooperating through its first end (4a) with a first end piece (6a), the second end (4b) of the central body (2a) of the last module (2) receiving a second end piece (6b).

17. A method for behavioral study, comprising the step of:
using the analysis device defined according to claim 1, by placing the analysis device in an open aquatic environment of at least one aquatic pollutant,
wherein the end pieces (6a, 6b) of the analysis device (1) each comprise at least one opening (8) defining an analysis device (1) mounted in an open circuit, the end piece (6a).

18. A method for behavioral study, comprising the step of:
using the analysis device defined according to claim 1, by placing the analysis device in a closed aquatic environment of at least one aquatic pollutant and/or at least one bacterial colony pre-seeded within a bacterial biofilm on a support,
wherein the analysis device (1) comprises two closed end pieces (6a, 6b), so as to generate a closed aquatic environment within the analysis device (1).

19. The method for behavorial study, according to claim 18, wherein the colony of bacteria growing within a biofilm covers a support in the form of a plastic film which constitutes an aquatic pollutant.

20. The method for behavioral study, according to claim 17, wherein the analysis device (1) comprises at least one auxiliary channel (23) and at least one auxiliary element, the auxiliary element being selected from the following list: a nutrient supply source, a pollutant supply source, an air supply source, an oxygen supply source, a measuring instrument, or a combination of these elements.

21. (canceled)
